(19) United States
(12) Patent Application Publication
(10) Pub. No.: US 2024/0098114 A1
(43) Pub. Date: Mar. 21, 2024

(54) System and Method for Identifying and Managing Cybersecurity Top Threats

(71) Applicant: Google LLC, Mountain View, CA (US)

(72) Inventors: Benjamin Withnell, New York, NY (US); Nalani Fraser, Los Angeles, CA (US); Christopher Key, Great Falls, VA (US)

(21) Appl. No.: 17/944,158

(22) Filed: Sep. 13, 2022

(51) Int. Cl. H04L 9/40

(52) U.S. Cl. CPC H04L 63/20; H04L 63/1441

(57) ABSTRACT

A computerized method features operations conducted by a security analyzer device to process incoming information to ascertain a presence of cybersecurity threats based on a top threat list provided to the security analyzer device. The top threat list includes a plurality of cybersecurity threats prioritized for an enterprise that is subscribing to a threat management system and protected by the security analyzer device. The computerized method further conducts analytics of incoming information to determine a level of correlation between at least a portion of the incoming information and any of the plurality of cybersecurity threats within the top threat lists content, and upon determining the level of correlation between the portion of the incoming information and a cybersecurity threat of the plurality of cybersecurity threats exceeding a first threshold, may conduct operations to neutralize or mitigate the cybersecurity threat.

### FIELD

Embodiments of the disclosure relate to the field of cybersecurity. More specifically, one embodiment of the disclosure relates to a system and method configured to automatically curate cyber-security intelligence for use in protecting an enterprise.

### GENERAL BACKGROUND

Cybersecurity attacks have become a pervasive problem for enterprises as many computing devices and other resources have been subjected to attack and compromised. A “cyberattack” constitutes an actualized threat to security of a computer network, network-connectable computing devices, controllers, stored or in-flight data, and other resources. The security threat may involve malware (malicious software) introduced into a computing device or network. The security threat may originate as an external threat or insider threat, such as negligent or rogue authorized users, sometimes involving stolen credentials. The security threats may represent malicious or criminal activity or even a nation-state attack. While conventional cybersecurity detection products are commonly used to detect indicators of compromise of networks and computing devices, most enterprises rely on the expertise of human cybersecurity personnel to track an enterprise's prevailing threat landscape, to prioritize threats against the enterprise, and to determine preventive and/or remedial actions for the enterprise in response to those alerts. Reliance on cybersecurity personnel to predict potential cyberthreats is problematic for a number of reasons.

First, experienced cyber-security analysts are in short supply relative to demand. Also, manual performance of analytics is not readily scalable in light of the increasingly numerous and sophisticated cyberthreats. As more attack vectors need to be evaluated, a cybersecurity analyst will often be unable to complete her or his analysis of data in a timely manner to protect the enterprise or remediate the threat without a corresponding increase in efficiency.

Second, given that enterprises are dynamic in nature, in some situations the cybersecurity expert may be working with incomplete or out-of-date data regarding the enterprise. For example, the complexity of an enterprise's deployed Information Technology (IT) architecture (e.g., networks, computing device types, supported operating systems, loaded software components, etc.) and deployment locations, as well as the efficacy of its cyber-security protection may lead to less accurate threat evaluations and lower success rates in preventing cyberthreats against the enterprise.

Lastly, given their extremely busy schedule, cybersecurity experts may not have sufficient time to review the increasingly voluminous amounts of cybersecurity intelligence in efforts to determine which cyberthreats pose the greatest threat of harm to the enterprise and should be prioritized for action. Given the large number of cyberthreats that may occur against an enterprise each day, security analysts are now spending a considerable amount of time simply trying to decide which cyberthreats to investigate. In many cases, the cyberthreats selected for investigation may not be directed to those cyberthreats most harmful to the enterprise.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 is a block diagram of an exemplary embodiment of cloud-based cybersecurity system including a threat management system configured to automatically identify and generate a list of top threats against an enterprise under evaluation.

FIG. 2A is a block diagram of an exemplary embodiment of threat management system of FIG. 1.

FIG. 2B is a general flow diagram of an exemplary embodiment of operations conducted by the ranking logic of the threat management system of FIG. 2A.

FIG. 3A is an exemplary embodiment of a communications between components deployed within the threat management system of FIG. 2A.

FIG. 3B is an exemplary embodiment of the operational flow between the threat management system and a first security analyzer device.

FIG. 3C is an exemplary embodiment of the operational flow between the threat management system and a second security analyzer device.

FIG. 3D is an exemplary embodiment of the operational flow between the threat management system and a third security analyzer device.

FIG. 4 is an exemplary embodiment of a threat catalog deployed within the threat management system of FIG. 2A.

FIG. 5 is an exemplary embodiment of a customer profile data store deployed within the threat management system of FIG. 2A.

FIG. 6 is an exemplary embodiment of a recommendation engine deployed within the threat management system of FIG. 2A.

FIG. 7 is an exemplary embodiment of an action engine deployed within the threat management system of FIG. 2A

FIG. 8A is an exemplary embodiment of an illustrative profile display interface generated by a threat management system of FIG. 2A and accessible by a customer associated with an enterprise via a portal or application programming interface (API).

FIG. 8B is an exemplary embodiment of a display interface generated by a reporting engine of the threat management system of FIG. 2A.

FIG. 8C is an exemplary embodiment of a display interface generated by the recommendation engine and action engine of the threat management system of FIG. 2A.

FIGS. 9A-9B is an exemplary embodiment of the operational flow of the threat management system to determine cyberthreats directed to an enterprise, rank the determined cyberthreats, and generate recommendation actions associated with at least a prescribed number of the top-ranked cyberthreats.

### DETAILED DESCRIPTION

It would be desirable to automate significant portions of the analysis process that cybersecurity analysts presently perform manually to identify the most significant cybersecurity threats (called herein, “top threats”), and take appropriate actions to address at least the top threats. To this end, it would be desirable to automate the process of curating (selecting, organizing, and presenting (e.g., on-line)) threat intelligence for use by security analysts.

Embodiments of the current disclosure generally relate to automated techniques to (i) filter threat intelligence to that relevant to an enterprise based on an enterprise profile containing information received over a network, e.g., via an interactive portal, (ii) classify and order cyberthreats to identify top threats faced by an enterprise based on a correlation of attributes of the cyberthreats with the enterprise profile, and/or (iii) based on the identified top threats, facilitate and prioritize preventive and/or remedial action. The preventive and/or remedial actions may include, but are not limited or restricted to (i) neutralizing the threat, (ii) conducting validation testing of security controls and their configurations to increase confidence in thwarting any of the top threats, (iii) examining customer's attack surfaces for vulnerabilities and weaknesses that would expose the enterprise to any of the top threats, and/or (iv) guiding cybersecurity analysts in monitoring networks and devices, and, in some cases, (v) initiating or recommending responsive actions or alerts. In general, the identified top threats can be used in guiding aspects of an enterprise's response to threat alerts and to an enterprise's unique threat landscape. Advantageously, security analysts can leverage the automation to identify and respond to the top threats in a timely and scalable fashion, reflecting the attributes, characteristics and interests of the enterprise.

For example, the above-described automated solution may be conducted by a threat management system, which may be configured to actualize collected threat intelligence for use in (i) prioritizing cybersecurity threats directed to enterprises subscribing to the threat management system and (ii) providing (e.g., routing) information to one or more security analyzer devices (hereinafter, “security analyzer device(s)”), to one or more security controls (hereinafter “security control(s)”), and between components within the threat management system in efforts to conduct one or more preventive and/or remedial actions against these cybersecurity threats (hereinafter, “threats”). Given that threat landscapes for different enterprises can vary significantly, depending on the industry and location of the enterprise for example, the threats most applicable to one enterprise may differ from threats applicable to other enterprises. For simplicity, as described herein, an “enterprise” is generally defined as any entity utilizing services provided by the threat management system, which may correspond to any company, partnership, organization, affiliation, governmental agency or department, or the like.

Herein, the threat management system is configured to (i) identify threats directed to a particular enterprise or a similarly situated enterprise and (ii) select a subset of the identified threats as top threats to which the enterprise is a likely target and prompt investigation and/or actions needed to neutralize or mitigate these top threats. A “top threat list” is a prioritized arrangement of the top threats, which may have different threat attributes, such as sourced by different threat actors, directed to different industries or geographic locations, evidenced by different IoCs (indicators of compromise) and/or TTPs of a threat actor (tools, tactics and/or techniques and procedures) to take advantage of enterprise vulnerabilities for example. The top threat list may be used in testing for security-related events, such as potential vulnerabilities in the particular enterprise (or a similarly situated enterprises), which may include, for example, but are not limited or restricted to: (i) software used within enterprise-based computing devices that are susceptible to attack, (ii) security practices observed by the enterprise which may not be sufficient to meet the cyber risks, and/or (iii) security control(s) with non-compliant (or non-recommended) configurations or settings that may expose the enterprise to an increased likelihood of a successful cyberattack.

According to one embodiment of the disclosure, the top threat list can be used to identify the most actionable threats for the enterprise and/or assist in generating actions to neutralize or minimize some of these threats. For example, the top threat list may be provided to one or more security analyzer devices (or to the enterprise itself) in order to identify vulnerabilities (described below) in the enterprise's cybersecurity posture and enable the enterprise to make informed business decisions in addressing these vulnerabilities.

Additionally, the top threat list may be relied upon to prioritize potential threats for investigation, notification, remediation, or another action. For example, the top threat list and related information may be provided to one or more security analyzer devices to (i) assess the operational health of an enterprise's network/computing devices from a security standpoint, and/or (ii) update an enterprise profile maintained within the threat management system based on returned information from the security analyzer device(s). Also, the top threats and related information may be used to instruct security controls deployed at the enterprise by sending appropriate command communications (instructions) to conduct operations in efforts to neutralize or mitigate each of these top threats.

According to one embodiment of the disclosure, a threat management system is configured to generate a top threat list based on a correspondence, such as at least a prescribed level of correlation, between content of an enterprise profile (e.g., a plurality of characteristics associated with the enterprise) and content of a threat catalog (e.g., a plurality of threat attributes each associated with a threat extracted from a compilation of known threats collected from one or more threat intelligence sources). More specifically, the top threat list is generated based on a correspondence (e.g., at least the prescribed level of correlation) between characteristics associated with the enterprise contained within the enterprise profile and threat attributes (e.g., threat actors, identified malware types, IoCs, TTPs, etc.) associated with each threat contained within the threat catalog. The selection of known threats included as part of the threat catalog for a particular enterprise may be based, at least in part, on certain characteristics included in an enterprise profile for the particular enterprise.

According to this embodiment of the disclosure, the threat management system features one or more processors and a non-transitory storage medium. The non-transitory storage medium includes, but is not limited or restricted to the following: a threat catalog, a plurality of enterprise profiles, a recommendation engine, an action engine, and a reporting engine.

Herein, deployed within a non-volatile and modifiable repository, the threat catalog is configured as a compilation of threat information related to thousands or tens of thousands of known cyberthreats (hereinafter, “cataloged threats”). The threat catalog may be a subset of accumulated known threats selected from a global threat intelligence system that maintains cyberthreats from a large number of intelligence sources such as different feeds from private, governmental, public sources (inclusive of so-called “open sources” provided under permissive licenses), cybersecurity partner(s), and/or internal sources such as threat information from analyses and investigations of threat actor activity conducted by security analyst or administrator associated with the enterprise. The selection of the cataloged threats in forming the threat catalog may be based, at least in part, on experiential knowledge and testing/analysis of types of data that are highly informative of and useful in dealing with threats more closely pertaining to characteristics of the enterprise under evaluation as represented by an enterprise profile.

Each threat may include, but is not limited or restricted to any or all of the following information: threat name, threat family, history, attack IoCs, TTPs, typical attack victims (e.g., industry, region, etc.), nature and extent of resulting damage from attack, dates of recent activity, threat score (a prescribed level of maliciousness), etc. Besides the threat information, each of the cataloged threats may include metadata, such as, for example, an identification of the source(s) of the threat (e.g., threat actor group, source website, Internet Protocol “IP” address, etc.) as described above as well as a quality value indicative of the reliability of that source and/or the prevalence of specific attribute(s) in observations of the threat.

While accessible to the recommendation engine as described below, the threat catalog is also accessed by one or more enterprise-based computing devices via an application programming interface (API) or a portal connected to a public and/or private network as described below.

As further described below, a profile data store is configured to maintain a plurality of enterprise profiles. An enterprise profile operates as a data record that specifies characteristics of an enterprise, where each characteristic is distinct and corresponds to information that represents that enterprise. The characteristics may be removed, added or updated based on information originating from a security analyst or administrator associated with the enterprise or a trusted source different than the enterprise. Herein, the characteristics may include at least internal data and external data. As an illustrative example, the “internal data” generally corresponds to information directed to the enterprise itself, such as its name, industry, and/or geographic location(s) or regions in which the enterprise occupies. In contrast, the “external data” may include information regarding the enterprise's operating environment such as business relationships.

As further described below, a recommendation engine includes correlation logic and ranking logic that are collectively configured to conduct analytics and prioritize threats, even though some or all of these threats are based on potential threats, not threats associated with an ongoing cyberattack. The analytics may involve a mapping, by the correlation logic, of threat attributes associated with threats contained in the threat catalog to enterprise characteristics set forth in the enterprise profile. The correlation logic determines a degree of relatedness between the enterprise characteristics and threat attributes.

More specifically, the correlation logic of the recommendation engine may operate as a type of threat filter, where the filtering is conducted based on enterprise characteristics captured within the enterprise profile and the threat attributes associated with different threats maintained in the threat catalog. The recommendation engine identifies (and reports) those threats that are sufficiently relevant to the enterprise under evaluation (hereinafter, “eligible threats”). In some cases, a single attribute or, in other cases, a plurality of attributes set out in the enterprise profile are sufficient to determine the relevance of the threat in the threat catalog to the enterprise. In some cases, a pattern of attributes of the enterprise profile are required to recognize the threat in the threat catalog is relevant.

The ranking logic of the recommendation engine receives the eligible threats and performs a ranking (or ordering) operation on these eligible threats. According to one embodiment of the disclosure, the ranking operation may involve analytics to determine levels of correlation between the enterprise characteristics and the attributes associated with the eligible threats, namely characteristic-attribute correlation levels. Examples of the characteristic-attribute correlation analytics may include, but are not limited or restricted to (i) how recently a threat actor targeted the enterprise's industry and/or region, (ii) whether the threat actor has exploited vulnerabilities in any software the enterprise is known to be using, (iii) a ranking of threat actors, (iv) a ranking of malware, and/or (v) a ranking of IoCs and TTPs pertaining to the malware or threat actors.

From these characteristic-attribute rankings, a top threat list may be formulated based on which of the cataloged threats feature the higher ranked character-attributes. In some situations, the cataloged threats feature the higher ranked character-attributes, provided severity levels assigned to the threats is equal to or exceeds a prescribed threshold. As a result, the rankings may be adjusted based on the severity of the threat, which can be represented by a threat score, and depends on a number of quantifiable risks such as levels of maliciousness, scope of infection, extent of potential damage/distribution to the enterprise, or the like. The rankings can be further adjusted in light of the confidence represented by a quality value associated with the accuracy/granularity of the threat attributes or the quality level associated of a reporting source of that threat.

As further described below, as an optional component, an action engine may be communicatively coupled to the recommendation engine. The action engine is configured to receive the top threat list produced by the ranking logic and generate an action list to complement each of the top threats set forth in the top threat list. For this, in some embodiments, the action engine looks-up each of the top threats in an actions data store (e.g., database) of recommended actions. The actions database may be configured to store recommended actions in a non-volatile memory corresponding to previously encountered threats or types (e.g., families) of threats that have proven themselves effective in mitigating cyber risk or damages. The top threat or related metadata can be used as an index into the actions database to retrieve the recommended action or actions for the top threat or type of threat corresponding to the top threat. According to one embodiment of the disclosure, the action list may include information (e.g., text, links, etc.) directed to suggested operations in accordance with a semi-automated process to instruct a customer (e.g., a security administrator, user, etc.) on operations to be conducted by enterprise-based security control(s) or off-site security analyzer device(s) to neutralize or mitigate the risk of a successful cyberattack associated with the identified threat and/or initiate further analyses. Additionally, or as an alternative, the action list may include commands in accordance with an automated process by directly sending these commands to security analyzer device(s) and/or the security control(s) identified by the enterprise (and preferably pre-identified during a set-up pre-production or set-up stage) and maintained in a security device database. The commands are used to control operability of the security analyzer device(s) and/or the security control(s) in efforts to neutralize or mitigate the risk associated with and/or damages caused by a successful cyberattack associated with the identified threat.

Herein, embodiments of the recommendation engine and/or action engine may be automated to allow a top threat list to be constantly updated with the most current information and enrich the reports of those top threats with additional details useful to defend against those threats. The reports may be printable (physical) documents, displayable results, results for processing by automated processes, or the like.

As further described below, a reporting engine is communicatively coupled to the recommendation engine. Herein, the report engine is configured to generate reports of the analytic results produced by the recommendation engine. The report from the recommendation engine may contain threats specific to the enterprise as well as information directed to the threats such as the threat's priority ranking or potential severity level (e.g., low, medium, high, or critical). The reports may also contain alerts to be triggered when the threat is encountered, recommended escalations, recommended remediation techniques, or the like. The report engine can also be communicatively coupled with the action engine to provide the enterprise with reports of recommended actions and their status, which may be output via the portal.

As described below, the threat management system features one or more interfaces to provide communications between components of the threat management system, such as interfaces between (i) the threat catalog repository and the recommendation engine, (ii) the recommendation engine and the profile data store, (iii) the recommendation engine and the action engine and associated databases and data stores, (iv) the recommendation engine and the reporting module, and/or (v) the action engine and the profile data store. The threat management system further features interfaces to support communications between (a) the threat catalog and its sources/feeds such as a global threat intelligence system, (b) the recommendation engine and security analyzer devices, (c) the recommendation engine and security controls, (d) the action engine and security analyzer devices, (e) the action engine and security controls, and/or (f) the threat catalog and consumer computing devices, and/or (g) the reporting engine and the consumer-based computing devices. The “enterprise-based computing devices” includes computing devices under control by the enterprise or a representative/agent of the enterprise, where the enterprise is provided access to the top threats, actions, or the like via a portal and/or an application programming interface (API).

The portal provides access for the consumer computing device(s) to obtain the top threat list and other information using an interactive graphical user interface. The API provides an interface to automated communications between the enterprise-based computing devices and the threat management system.

### II. Terminology

In the following description, certain terminology is used to describe aspects of the invention. In certain situations, the terms “engine,” “logic” and “component” are representative of hardware, firmware, and/or software that is configured to perform one or more functions. As hardware, the engine (or logic or component) may include circuitry having data processing and/or storage functionality. Examples of such circuitry may include, but are not limited or restricted to a processor, a programmable gate array, a microcontroller, an application specific integrated circuit, wireless receiver, transmitter and/or transceiver circuitry, semiconductor memory, or combinatorial logic.

Alternatively, or in combination with the hardware circuitry described above, the engine (or logic or component) may be software in the form of one or more software modules, which may be configured to operate as its counterpart circuitry. For instance, a software module may be a software instance that operates as a processor, namely a virtual processor whose underlying operations is based on a physical processor such as virtual processor instances for Microsoft® Azure® or Google® Cloud Services platform or an EC2 instance within the Amazon® AWS infrastructure, for example.

Additionally, a software module may include an executable application, a daemon application, an application programming interface (API), a subroutine, a function, a procedure, an applet, a servlet, a routine, source code, a shared library/dynamic load library, or even one or more instructions. The software module(s) may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, a hard disk drive, an optical disc drive, a portable memory device, or storage instances as described below. As firmware, the engine (or logic) may be stored in persistent storage.

The term “computerized” generally represents that any corresponding operations are conducted by hardware in combination with software and/or firmware.

The term “malware” is directed to software that produces a malicious behavior upon execution, where the behavior is deemed to be “malicious” based on enterprise-specific rules, manufacturer-based rules, or any other type of rules formulated by public opinion or a particular governmental or commercial entity. This malicious behavior may include any unauthorized, unexpected, anomalous, and/or unwanted behavior. An example of a malicious behavior may include a communication-based anomaly or an execution-based anomaly that (1) alters the functionality of an electronic device executing that application software in a malicious manner; and/or (2) provides an unwanted functionality which may be generally acceptable in other context.

Herein, an “IoC” (indicator of compromise) generally constitutes data that is representative of a malicious, suspicious or abnormal event experienced by the enterprise.

A “TTP” (tactics and/or techniques and procedures) of threat actor generally constitutes data that is representative of one or more patterns of behavior, which can be monitored in efforts to defend against specific strategies and certain threat vectors used by threat actors or perpetrators.

The term “computing device” should be generally construed as physical or virtualized device with data processing capability and/or a capability of connecting to any type of network, such as a public cloud network, a private cloud network, or any other network type. Examples of a computing device may include, but are not limited or restricted to, the following: a server, a router or other intermediary communication device, an endpoint (e.g., a laptop, a smartphone, a tablet, a desktop computer, a netbook, IoT device, industrial controller, etc.) or virtualized devices being software with the selected functionality.

A “security analyzer device” may constitute a physical or virtual computing device that may be (i) used a security analyst, who may work directly for the enterprise or for a third-party security vendor retained by the enterprise or (ii) provisioned to perform the functions of a security analyst such as, for example, through the use of a trained, deep machine learning model. Examples of different types of security analyzer device may include, but is not limited or restricted to security controls (SOC), security validation module (SVM), attack surface management system (ASMS), and/or an incident response module.

“Security controls” generally refers to a product, whether deployed on-premises or cloud-based, designed to monitor and/or collect events and occurrences observed in a computing device (including log events), and/or network communications (sent and/or received). The collected events may include, though may or may not be classified by the security controls as, indicators of compromise, malicious behaviors, or other evidence of cyber-attacks. The security controls may issue alerts or reports on detected events or occurrences. Examples of security controls include malware detection systems, anti-virus software, and firewalls, to name a few.

A “security validation module” (SVM) may generally refers to a service featuring logic located on-premises for the enterprise and cloud-based. The logic is configured to test a customer's deployed products to assess their effectiveness directly, and possibly avoid additional expenditures for controls or refocus existing controls. In response to a top threat (e.g., new alert or routine retesting focused on top threats), malware may be selected, automatically or by a security analyst, for use in testing, prioritizing validation tests to expedite results. The selection of the malware may be based, at least in part, on an area within the proprietary network to be tested and/or the security controls to be tested. In response to test results, the SVM may be configured to fix misconfigurations or add another line of defense to avoid weaknesses in network security.

The “attack surface management system” (ASMS) may be deployed entirely within a public or private cloud network or on-premises, where the ASMS is configured to perform entity discovery and monitoring. Such operations are conducted to (i) detect additional threats and/or modifications to threats based on local enterprise analytics, (ii) provide asset inventory that may be used to modify an enterprise profile, and/or (iii) guide vulnerability discovery of the enterprise.

The “incident response module” is logic directed to perform operations in accordance with a set of information security policies and/or procedures to identify, contain, and/or eliminate a cyberattack on resources at an enterprise.

The term “message” generally refers to as information placed in a prescribed format that is transmitted in accordance with a suitable delivery protocol or accessible through a logical data structure such as an Application Programming Interface (API) or a web service or service such as a portal. Examples of the delivery protocol include, but are not limited or restricted to HTTP (Hypertext Transfer Protocol); HTTPS (HTTP Secure); Simple Mail Transfer Protocol (SMTP); File Transfer Protocol (FTP); iMESSAGE or iCLOUD Private Relay; Instant Message Access Protocol (IMAP); or the like. For example, a message may be provided as one or more packets, frames, or any other series of bits having the prescribed, structured format.

As described herein, a threat management system may be deployed, for example, as a part of a “cloud-based hosted service,” a “hosted service,” or a combination thereof, any of which operates to generate a preferably ranked list of cybersecurity threats that apply to a subscribed enterprise, and optionally, recommended modification(s) of the enterprise functionality (or commands) to combat the cybersecurity threats. The threat management system is configured to interact with security analyzer devices or security controls to provide a holistic viewpoint of the threat landscape directed to the enterprise. The security analyzer devices and security controls can each be either cloud-based or on-premises and can be co-located with or remote from the threat management system.

As a cloud-based hosted service, the threat management system may be configured to operate as a multi-tenant service; namely a service made available to tenants (e.g., separate enterprises) on demand via a public network (e.g., Internet). The multi-tenant service may feature virtual resources, such as virtual processors, virtual machines, and/or virtual data stores for example, which are partitioned for use among the enterprises in accessing and/or analyzing data maintained within that enterprise's specific cloud account. The partitioning protects the security and privacy of the enterprise data. In contrast, as a hosted service, the threat management system may be configured as a single-tenant service installed on on-premises server(s) to access and collect information associated with an enterprise or multiple (two or more) enterprises where the tenant is a conglomerate formed of separate, and distinct enterprises.

In certain instances, the terms “compare,” comparing,” “comparison,” or other tenses thereof generally mean determining if a match (e.g., identical or a prescribed level of correlation) is achieved between information associated with two items under analysis. Also, the phrase “one or more” may be denoted by the symbol “(s)” such as “one or more elements” may be represented as “element(s)”.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

### III. Platform Deployment—Threat Management System

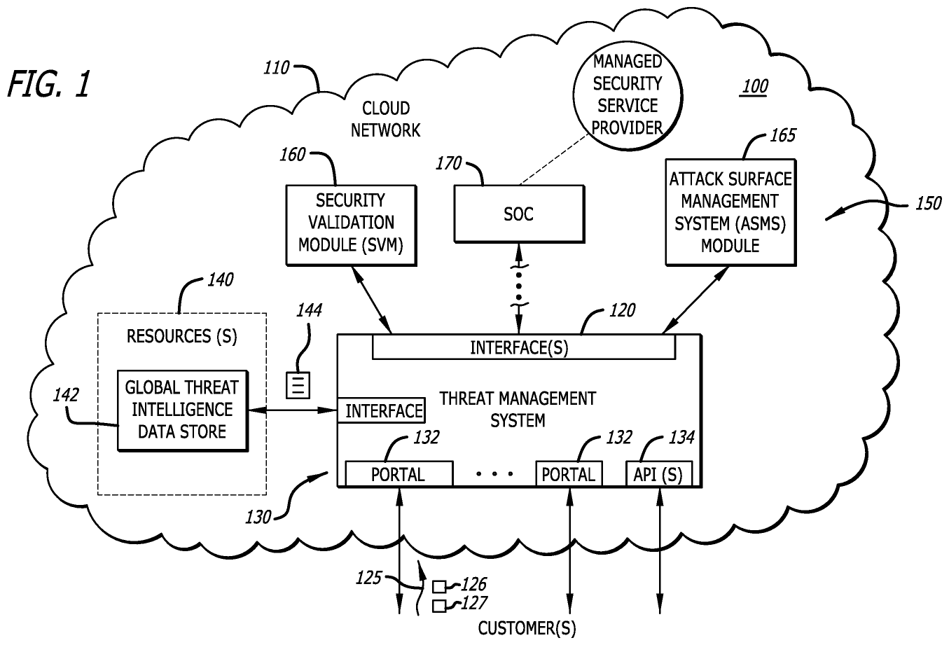

Referring to FIG. 1, a block diagram of an exemplary embodiment of cloud-based cybersecurity system 100 operating as a service within a cloud network 110 (e.g., public or private cloud network) is shown. The cybersecurity system 100 features a threat management system 120 that is configured, in response to a triggering event, to automatically identify and generate a list of top threats against an enterprise. The triggering event may be manually and/or automatically initiated. For example, as shown in FIG. 1, a manual triggering event may include a request message 125 initiated by a customer (e.g., representative of the enterprise such as a security administrator, a user, etc.) for a threat assessment of an enterprise identified in the request message. Provided via a front-facing interface 130 (e.g., portal(s) 132, application programming interface “API” 134, etc.), the request message 125 may include an enterprise identifier (hereinafter, “enterprise ID”) 126 and customer credentials 127 to verify whether the customer has access rights to initiate a threat assessment for the enterprise identified by the enterprise ID 126. Although not shown in detail, an automatic triggering event may be a scheduled event, namely time-based analytics by the threat management system 120 occurring at a schedule time and providing the enterprise ID 126 to identify an enterprise to which the threats are directed (e.g., analytics conducted daily for security administrators to understand the most urgent threats to investigate that day).

Herein, the cloud network 110 (e.g., a public cloud network such as Microsoft Azure®, or Amazon Web Services®, or Google Cloud®, etc.) is a fully virtualized, multi-tenant cloud service made available through one or more data centers (not shown). Each data center(s) includes a plurality of servers maintained by a provider of the cloud network 110. The servers include logic, operating as virtual resources, which are offered by the cloud network 110 and made available to a large number of enterprises. As an illustrative example, the threat management system 120 may be maintained with cloud-based storage (e.g., non-transitory storage medium represented as a storage instance such one or more S3 storage instances within Amazon Web Services®, etc.) and processed by processor (e.g., a virtual processor as one or more processor-based instances such as EC2 instances within Amazon Web Services®, etc.).

The threat management system 120 includes a plurality of interfaces to enables communications with one or more resources 140 (hereinafter, “resource(s)”) and one or more security analyzer devices 150 (hereinafter, “security analyzer device(s)”). Herein, the resource(s) 140 may include a global threat intelligence data store 142, which operates as a database or repository to receive and store cybersecurity intelligence. The cybersecurity intelligence may include information associated with a plurality of threats. Each threat may have been previously analyzed as a source (e.g., threat actor, website, etc.), an object (e.g., file, message provided as network data, etc.) or a factor (e.g., threat vector, etc.) involved in a cyberattack or an attempted cyberattack. In general terms, the global threat intelligence data store 142 contains the entire stockpile of cybersecurity intelligence collected and used by enterprises, which is continuously updated (through a process akin to “crowd sourcing”) by the various intelligence sources (where some of the cybersecurity intelligence may be derived from cyber expert analyses at these sources) and by the threat management system 120 itself to maintain its currency and relevancy. The global threat intelligence data store 142 may be implemented as a cloud service to receive analytic results from other cloud services.

As shown in FIG. 1, the global threat intelligence data store 142 provides a subset of the cybersecurity intelligence—which is curated so as to be limited to those directed to threats pertinent to each subscribed enterprise, referred to as a “threat catalog” 144—to the threat management system 120. The threat catalog 144 is relied upon by the threat management system 120 to determine potential threats associated with an enterprise to which the threat catalog 144 applies. Stated differently, a “threat catalog” refers to a compilation of cyberthreats that have been collected by, for example, a government, open source, or other public sources, or well-connected cybersecurity company with access to a variety of sources (hereinafter, “feeds”). While the global threat intelligence data store 142 may be a primary source of the threat catalog 144, some of the security analyzer devices 150 may be other sources, such as a security validation module 160, attack surface management system (module) 165, security operations center (SOC) 170 monitoring for threats at enterprises in real-time, for example.

More specifically, the security validation module 160 is configured to provide an internal view of an enterprise's readiness to defend against cyberattacks, as seen through an attacker's eyes. Based on analytic results produced from the threat management system 120, such as a top threat list described below, a “test” malware (pertaining to at least one of the top threats) may be safely injected into a proprietary network of the enterprise. The success of security controls associated with the enterprise (e.g., endpoint security, network security, firewalls, security information and event management (STEM) products from one or more vendors) in detecting/blocking the injected test malware is reported as an indication of the effectiveness of those security controls, and, in some instances, of the proper configuration and update of those controls. Knowledge of the top threats can be used to select the malware used in testing and guide areas of in-depth testing of the security control(s).

The attack surface management system 165 is configured as a software module that, during operation, provides an external view of an enterprise's susceptibility to an attack, as seen through an attacker's eyes. This software module performs entity discovery and monitoring, as well as vulnerability discovery (per public records of vulnerabilities) across deployed assets within the customer's network. Knowledge of the top threats determined by the threat management system 120 may be used by the attack surface management system 165 to guide areas of in-depth investigation, such as potential vulnerabilities for example.

The SOC 170 is adapted to receive alerts from security control(s) of an enterprise (e.g., endpoint security, network firewalls, etc.) and monitor/investigate cyber-threats noted by the alerts as well as escalate those that require a response. Herein, the top threats can be used by the SOC 170 to prioritize the incoming alerts (and the threats they represent) in order to handle any threats associated with the alerts that correspond to any of the top threats. Furthermore, the “top threats” can be used in prioritizing actions (e.g., blocking, remediation, quarantining, etc.) that may be required to mitigate the risks associated with the threats.

### IV. Architecture—Threat Management System

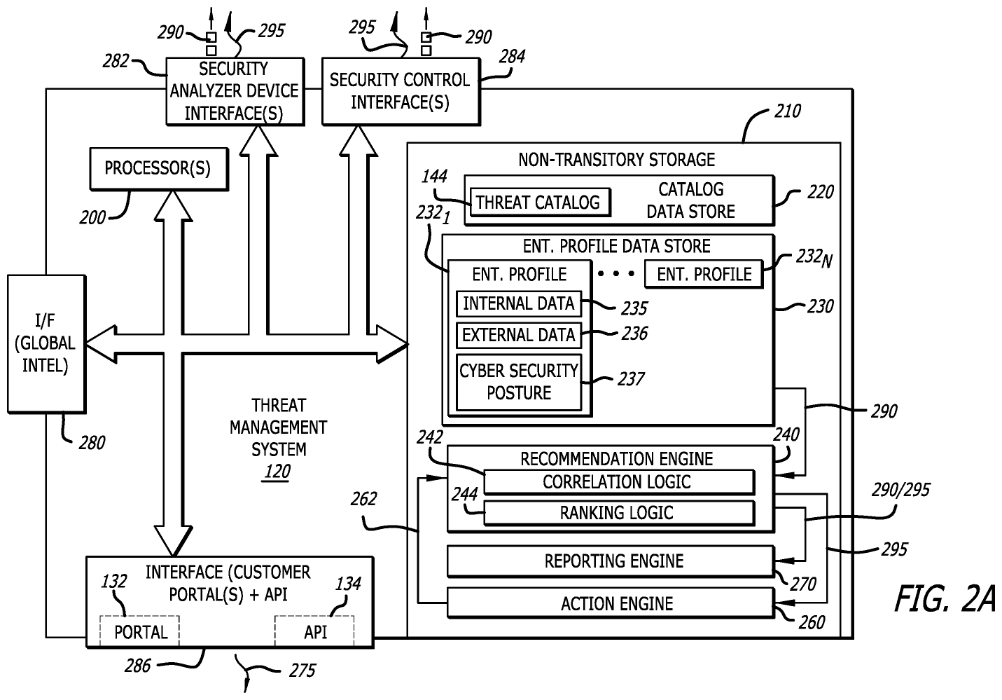

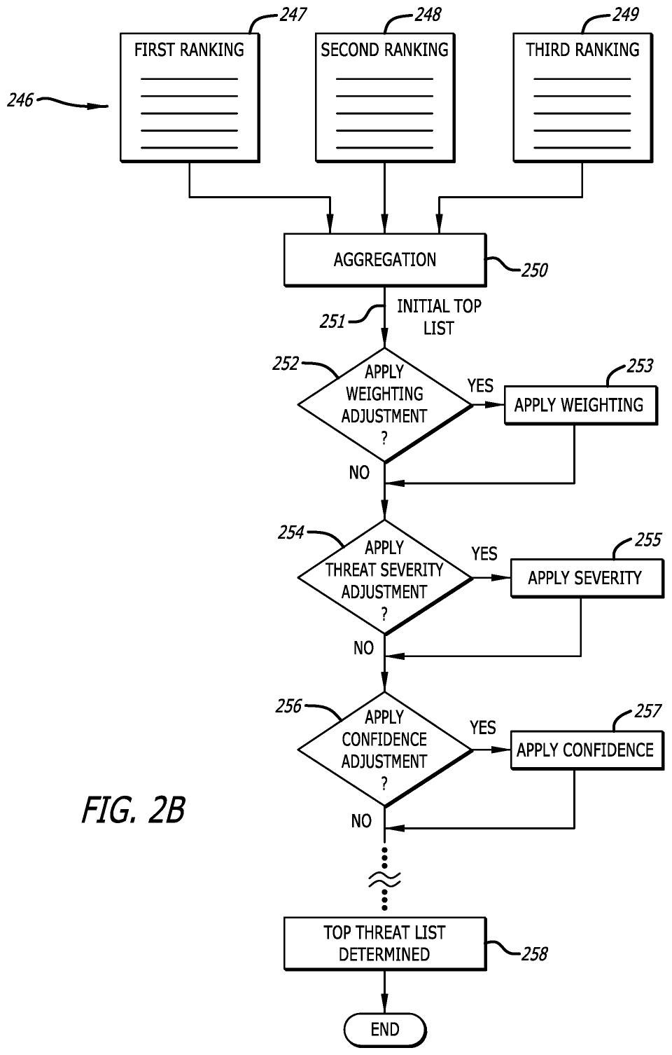

Referring now to FIG. 2A, an exemplary embodiment of the threat management system 120 of FIG. 1 is shown. In general, the threat management system 120 is configured to generate top threats 290 against an enterprise under evaluation (hereinafter, simply “enterprise”). The top threats 290 are generated based on a correspondence (e.g., prescribed levels of correlation, etc.) between (i) content within a stored profile featuring characteristics associated with an enterprise (e.g., targeted enterprise profile 232₁) and (ii) content of the threat catalog 144 featuring a collection of threats pertaining to the enterprise. The content stored within the targeted enterprise profile 232₁ may constitute characteristics associated with the enterprise that are provided by the customer directly and data gathered from the security analyzer devices 150 of FIG. 1. The content stored within the threat catalog 144 may constitute a subset of threat attributes extracted from the global threat intelligence data store 142, where the threats may be selected based on certain characteristics included in the targeted enterprise profile 232₁ such as the enterprise's industry and location, for example.

According to this embodiment of the disclosure, the threat management system 120 features one or more processors 200 and a non-transitory storage medium 210. The non-transitory storage medium 210 includes, but is not limited or restricted to a threat catalog data store 220, a profile data store 230, a recommendation engine 240, an action engine 260, and a reporting engine 270.

A. Threat Catalog

Herein, the threat catalog data store 220 may constitute a non-volatile repository, which is configured to store the threat catalog 144 corresponding to a compilation of threat attributes related to tens, hundreds or thousands of cataloged threats, especially known threats (cyberthreats) that may be faced by a particular enterprise. The selection of the cataloged threats in forming the threat catalog 144 may be based, at least in part, on experiential knowledge and testing/analysis of types of data that are highly informative of and useful in dealing with threats pertaining to characteristics of the enterprise included within the enterprise profile 232₁. The threat attributes may include, but is not limited or restricted to any or all of the following: threat name, threat family, history, the source(s) of the threat (e.g., threat actor, source website, Internet Protocol “IP” address, etc.), a quality value indicative of the reliability of that source and/or the prevalence of specific attribute(s) in observations of the threat, attack IoCs, TTPs, typical attack victims (e.g., industry, region, etc.), nature and extent of resulting damage from attack, dates of recent activity, threat score (determination of at least a prescribed level of maliciousness), or the like.

Herein, the threat catalog 144 is accessible to the recommendation engine 240, which relies on contents of the threat catalog 144 to produce the top threats 290. Additionally, the threat catalog 144 may be accessed by one or more enterprise-based computing devices via an application programming interface (API) 134 or a portal 132 connected to a public and/or private network. The portal 132 enables a customer associated with an enterprise to gain access to the threat catalog 144 via an enterprise-based computing device. The portal 132 also provides access for the enterprise-based computing device(s) to obtain a top threat list 295 and other information using an interactive graphical user interface. For example, the portal 132 can receive a query message from a customer and generally returns threat information maintained by the threat catalog 144, where the query message may be submitted in a form that takes advantage of natural language and Boolean logic search engines.

The API 134 provides an interface that supports automated access of components of the threat management system 120, such as the threat catalog 144 or a top threat list 295 (e.g., an ordered arrangement of the top threats 290) of FIGS. 2A-2B for example, by the enterprise-based computing device. The API 134 provides an interface to automate communications between enterprise-based computing devices (not shown) and the threat management system 120.

B. Enterprise Profile(s)

The profile data store 230 is configured to maintain a plurality of enterprise profiles 232₁-232_{N} (N≥2). Each enterprise profile 232₁ . . . or 232_{N} may operate as a data record corresponding to a profile for an enterprise supported by the threat management system 120. For instance, the targeted enterprise profile 232₁ may be configured to include specific characteristics of a first enterprise, where the characteristics may be distinct and differ from characteristics associated with an enterprise profile 232₂ associated with a second (different) enterprise. The characteristics within the targeted enterprise profile 232₁ may be removed, added or updated based on information provided by the enterprise directly (via portal or API) or a trusted source different than the enterprise (e.g., security analyzer devices).

Herein, according to one embodiment of the disclosure, the characteristics maintained within each of the enterprise profiles 232₁-232_{N} may include internal data 235 and external data 236. As an illustrative example, the internal data 235 generally corresponds to information directed to the enterprise itself. Examples of internal data 235 may include, but is not limited or restricted to its name(s) (e.g., trade name(s), trademark(s) and/or service mark(s)), industry, vertical market, enterprise type (e.g., business, non-profit, vertical or sector, etc.), ownership (e.g., public or private), types of products and services offered by the enterprise, and/or geographic location(s) or regions in which the enterprise occupies. In contrast, the external data 236 may include information regarding the enterprise's operating environment in relation to other entities, such as its partners, resellers, competitors, suppliers, and consumers.

Besides the internal data 235 and/or the external data 236, each enterprise profile 232₁-232_{N} may also include information regarding the enterprise's cybersecurity posture 237. The cybersecurity posture 237 may include information associated with cyberattack or cyberthreat histories for the enterprise. Hence, an enterprise profile (e.g., the targeted enterprise profile 232₁) may be formulated and modified at least based on (i) data provided by an enterprise representative (e.g., security administrator, user, etc.) and/or (ii) analytic results provided from a security analyzer device such as a security validation module 160, the attack surface management system 165 and/or the SOC 170 via interface 282.

For example, the analytic results from secure analyzer devices 150 of FIG. 1 may provide further enterprise information, asset inventory (e.g., information directed to components (software and/or hardware) hosted by the enterprise), and/or vulnerabilities of these assets and networks accessed by these assets. The vulnerabilities may be uncovered by the security validation module 160 through direct testing of a network infrastructure utilized by the enterprise, or, if known, may be specified by the enterprise.

C. Recommendation Engine

The recommendation engine 240 includes correlation logic 242 and ranking logic 244 that are collectively configured to conduct analytics to identify threats pertaining to an enterprise under evaluation (e.g., a first enterprise) and prioritize the identified threats, where some or all of these prioritized threats are potential threats that are not part of an ongoing cyberattack against the enterprise. Herein, the correlation logic 242 is configured to conduct a mapping of threat attributes in the threat catalog 144 to enterprise characteristics in the targeted enterprise profile 232₁. Thereafter, the correlation logic 242 determines a degree of relatedness between these corresponding enterprise characteristic and threat attribute pairings. According to one embodiment of the disclosure, the enterprise characteristics relied on for the analysis may include, but are not limited or restricted to industry, location, market vertical, product/service offering, size, and/or other characteristics recorded in the targeted enterprise profile 232₁. From these characteristics, threats that pertain to the industry and/or location to which the first enterprise belongs (e.g., threat actor targeted industry/location, malware directed to the targeted industry/location, etc.) and threats identified by the first enterprise as the most important threats to monitor may be assigned higher degrees of relatedness.

Stated differently, the recommendation engine 240 may operate as a type of threat filter, where the filtering is conducted based on enterprise characteristics captured within the targeted enterprise profile 232₁ and the threat attributes associated with different threats maintained in the threat catalog 144. In some embodiments, various enterprise characteristics may be used as an index into the threat catalog 144. As an illustrative example, where (1) the characteristics included in the targeted enterprise profile 232₁ identify that the first enterprise belongs to a first industry type, features computing device installations with a prescribed location or region and/or provides certain types of products and/or services and (2) particular threat attributes associated with the threats maintained within the threat catalog 144 identify that the threats are actively attacking enterprises that are involve the first industry, feature computing device installations at the prescribed location, and/or provide the certain type(s) of products and/or services, the recommendation engine may conclude, through its correlation logic 244, that these threats are highly correlated threats (hereinafter, “eligible threats”) against the first enterprise.

The recommendation engine 240 is configured to identify the eligible threats and, when requested by the consumer (e.g., the enterprise or its security vendor), report the eligible threats. Herein, the correlation logic 242 may determine the degree of relevance of a threat within the threat catalog 144 against the first enterprise based on the number and/or types of threat attributes matching characteristics of the targeted enterprise profile 232₁. For example, the matching of a threat actor group (first threat) actively targeting enterprises in the energy (utilities) industry to which the first enterprise belongs may be deemed more relevant than a more widely distributed malware such as pop-up malware for example (second threat) directed to a large number of industries to which the first enterprise belongs, even though a greater number of threat attributes for the second threat match characteristics of the first enterprise.

Referring to both FIGS. 2A-2B, the ranking logic 244 of the recommendation engine 240 is configured to receive the eligible threats from the correlation logic 242 and perform a ranking (or ordering) operation on the eligible threats. According to one embodiment of the disclosure, the ranking operation may involve threat ordering analytics, where the ranking logic 244 determines levels of correlation between characteristics of the enterprise under evaluation and attributes associated with the eligible threats, namely characteristic-attribute correlation levels. For instance, the characteristic-attribute correlation levels may be determined based, at least in part, on separate rankings of different characteristic-attribute pairings 246 and an aggregation 250 of these rankings. This “aggregation” may include the collection of rankings of similar or related characteristic-attribute pairings (e.g., rankings directed to identical or related threat attributes, etc.) followed by an operation to normalize the rankings into an overall ranking (e.g., average rankings, etc.). The aggregation 250 of these characteristic-attribute rankings may undergo a weighting process (as described below) or may remain unweighted.

As an illustrative example, as shown in FIG. 2B, the ranking logic 244 may be configured to conduct a plurality of rankings 246 of different characteristic-attribute pairings 246 based on comparisons between the characteristics within an enterprise profile (e.g., the targeted enterprise profile 232₁) and the threat attributes within the threat catalog 144 that produced the eligible threats. For this example, the plurality of rankings 246 may include (i) a first ranking 247 of threat actors taking in account the enterprise's industry, (ii) a second ranking 248 of malware to which the enterprise is susceptible taking into account the contents of internal data within the enterprise profile, and/or (iii) a third ranking 249 of IoCs and TTPs pertaining to the threat actor taking into account attack vectors or vulnerability of higher concern to the enterprise. Each of these characteristic-attribute pairings may include metadata (e.g., threat identifier) to associate each ranked threat attribute with its corresponding threat.

From these characteristic-attribute rankings 247-249 and corresponding metadata, an initial top threat list 251 (corresponding to a prescribed number of cataloged threats (identified by threat identifiers) having the highest overall ranking after the aggregation 250 of the characteristic-attribute rankings 247-249) is determined.

After generation of an initial top threat list 251, the ranking logic may be configured to apply ranking adjustments that may produce the top threat list 295 different from the initial top threat list 251. The adjustments may be based on one or more factors, such as the weighting of the characteristic-attribute rankings (operations 252-253 of FIG. 2B), the threat severity (operations 254-255 of FIG. 2B), and/or confidence in the threat attributes (operations 256-257 of FIG. 2B), where applicable.

A first factor may be directed to applying a weighting of different aggregated characteristic-attribute rankings to place more importance on some rankings and less importance on others. For example, the threat actor ranking and the malware ranking may be assigned a greater weighting than the IoCs/TTPs ranking, where the weighting may be conducted to take into account the current threat landscape or customer preferences. However, according to another embodiment of the disclosure, no weighting may be applied.

A second factor may be directed to the severity levels assigned to the threats. According to one embodiment of the disclosure, the threat severity level may be used to exclude threats from the top threat list with severity levels that are less than a first prescribed risk threshold. As a result, threats that are highly applicable to the enterprise, but the severity of the threat is low, may fall lower (or fall off) of the top threat list. Additionally, or in the alternative, the threat severity level may be used to adjust the overall rankings in which threats with higher severity levels may be elevated up the top threat list, such as moderate evaluation where each range of overall rankings may be adjusted in accordance with the severity level for each eligible threat.

Herein, a severity level may can be represented by a threat score depends on a number of quantifiable risks. These risks may include determined levels of maliciousness and/or scope, extent of potential damage/distribution to the enterprise based on heuristics of similarly situated enterprises subject to a cyberattack, the urgency of remediation, or other risk factors inclusive of the active threat actors and/or malware pertaining to the on heuristics associated with the damage caused by such cyberattacks.

A third factor may be directed to a ranking adjustment based on a confidence in the accuracy of the threat attributes. This confidence may be represented by a quality value associated with the threat (e.g., details of the threat attributes used in the correlation) or the quality level can be associated with the original reporting source for that threat. Therefore, the priority of threat attributes associated with eligible threats that feature a confidence below a second prescribed threshold may be reduced.

Alternatively, in lieu of the top threat list 295 formulated on a threat-by-threat listing, the ranking logic 244 may be configured to generate a tier segmentation of the threats, where threats with certain threat scores are clustered together. The top threat list may be provided as a listing of threats within each threat tier group that may be segmented by threat score associated with the threats.

In summary, the operability of the correlation logic 242 and the ranking logic 244 may be semi-automated in which actions are needed by the customer or may be automated to allow the top threat list to be updated to the most current information in response to changes in the threat catalog 144 or the enterprise profile 232₁. These automated updates may be conducted periodicity to ensure that resources allocated in protecting the enterprise from cyberattacks are utilized efficiently, and reports of those top threats may be enriched with additional details useful to defend against those threats.

D. Action Engine

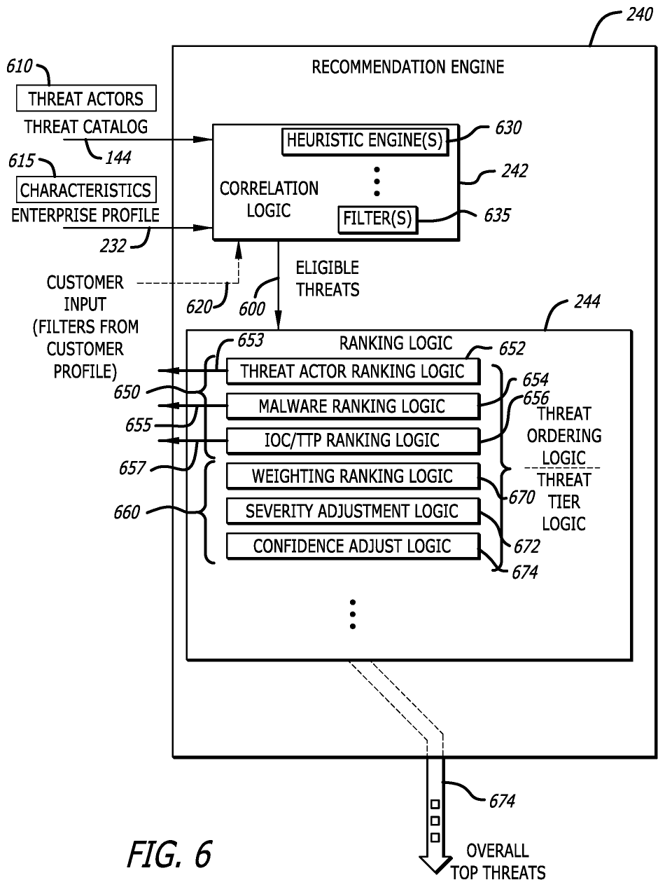

Referring back to FIG. 2A, as an optional component, the action engine 260 may be communicatively coupled to the recommendation engine 240. The action engine 260 is configured to receive the top threat list 295 produced by the ranking logic 244 of the recommendation engine 240 and generate an action list 262 to complement each of the top threats. The architecture of the action engine 260 is described below and illustrated in FIG. 6.

According to one embodiment of the disclosure, the action list 262 may include information (e.g., text, links, etc.) directed to suggested operations to be conducted by a customer on or by the security analyzer device(s) and/or the security control(s) to neutralize or mitigate the risk of a successful cyberattack associated with the identified threat. According to another embodiment of the disclosure, the action list 262 may include commands directly sent to security analyzer device(s) and/or the security control(s) to control their operability in efforts to neutralize or mitigate the risk of a successful cyberattack associated with the identified threat. The commands may be sent automatically (automated) or in response to active selection of the action by the security administrator (semi-automated).

E. Reporting Engine

The reporting engine 270 is communicatively coupled to the recommendation engine 240. Herein, the report engine 270 is configured to generate a report 275 of the analytic results produced by the recommendation engine 240. The report 275 may contain a curated list of threats specific to the enterprise, along with other germane information from the threat catalog such as the threat's priority ranking, potential severity level (e.g., low, medium, high, or critical), nature and scope of impact, likely vulnerability exploited, etc. The report 275 may further contain alerts to be triggered when the threat is encountered, recommended escalations, recommended remediation techniques, or the like. The report 275 may also contain a recommendation of validation procedures to be conducted by the security analyzer device(s) to test, by identification, retrieval and injection of test malware (corresponding to a particular type of malware associated with one of the top threats) into an enterprise's network, whether currently installed security control(s) are likely to block or at least detect one or more of the top threats.

As described below, the threat management system 120 features one or more interfaces to provide communications between components of the threat management system, such as interfaces between (i) the threat catalog repository and the recommendation engine, (ii) the recommendation engine and the profile data store, (iii) the recommendation engine and the action engine, (iv) the recommendation engine and the reporting module, and/or (v) the action engine and the profile data store. The threat management system further features interfaces 280-286 to support communications between (a) the threat catalog and its sources/feeds such as a global threat intelligence system (interface 280), (b) the recommendation engine and security analyzer device(s) (interface 282), (c) the recommendation engine and security control(s) (interface 284), (d) the action engine and security analyzer device(s) (interface 282), (e) the action engine and security control(s) (interface 284), and/or (f) the threat catalog and consumer computing devices (interface 286), and/or (g) the reporting engine and the consumer-based computing devices (interface 286). The “enterprise-based computing devices” includes computing devices under control by the enterprise or a representative/agent of the enterprise, where the enterprise is provided access to the top threats, actions, or the like via the enterprise portal 132 and/or API 134.

### V. Operational Flow—Threat Management System

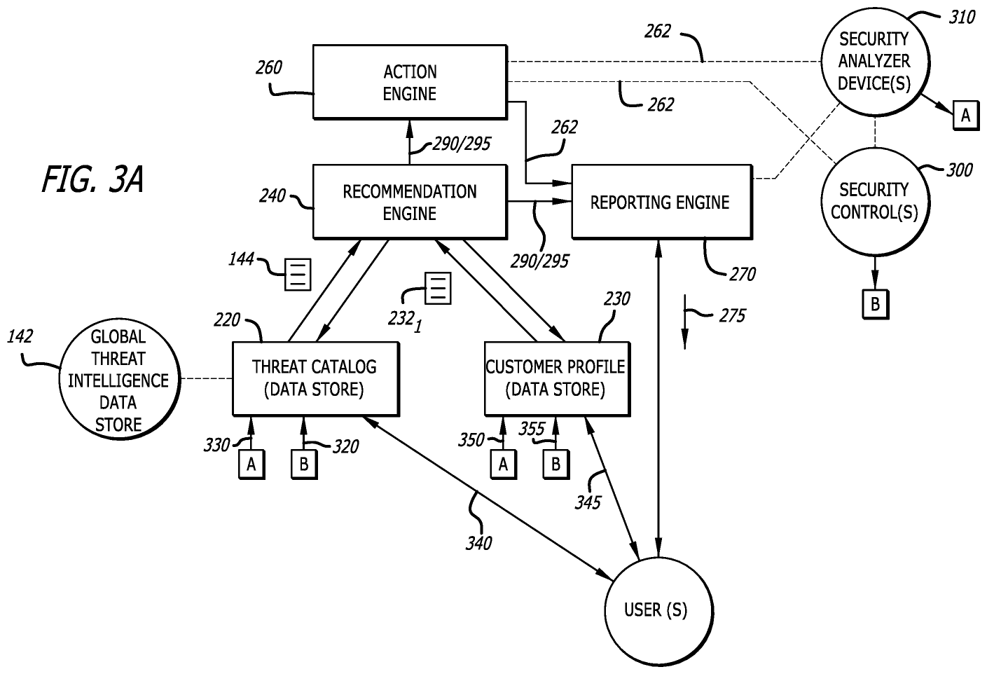

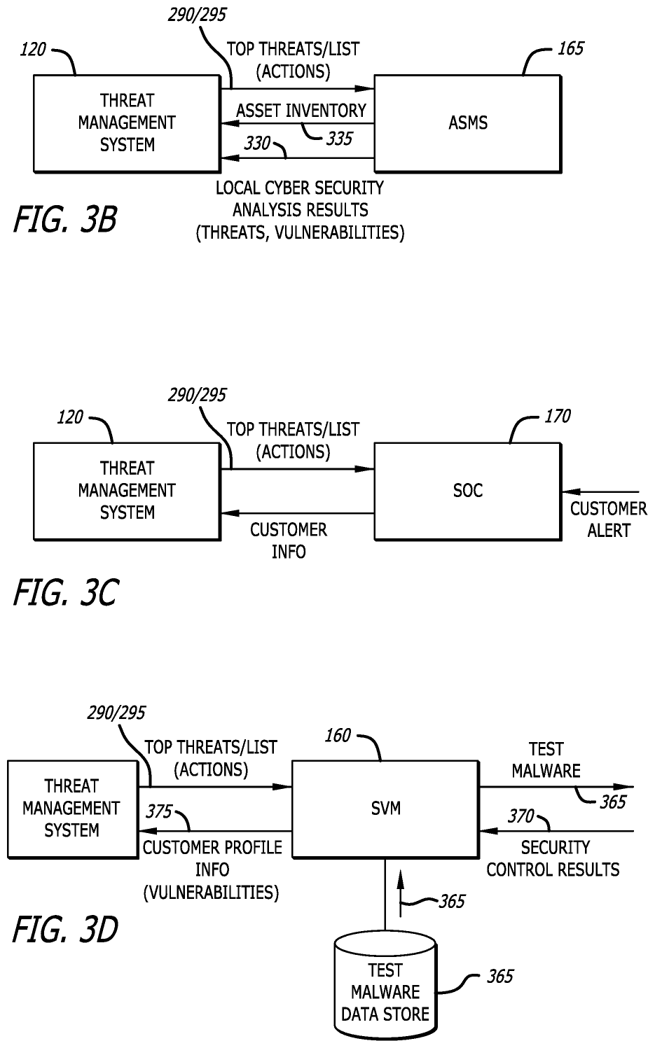

Referring to FIG. 3A, an exemplary embodiment of a communications between components deployed within the threat management system 120 of FIG. 2A is shown. Herein, as illustrated in FIG. 2A, these components include the threat catalog data store 220, the profile data store 230, the recommendation engine 240, the action engine 260, and the reporting engine 270.

Herein, to identify top threats against an enterprise, the recommendation engine 240 is configured to retrieve the threat catalog 144 stored within the threat catalog data store 220. As described above, the threat catalog 144 features a subset of the stored threats maintained within the global threat intelligence data store 142, where the subset of stored threats correspond to cataloged threats that more readily pertain to the characteristics of the enterprise (under evaluation). Each of the cataloged threats may be represented by threat attributes and metadata. The metadata includes identification of the threat source(s), and, in some embodiments, a quality value indicative of the reliability of the source that provided the information regarding the threat and/or the prevalence of a specific attribute in observations of the threat.

As further shown, the threat catalog 144 may be updated to include additional threats or modifications to the attributes associated with a previously identified threat based on communications from security control(s) 300 and/or the security analyzer device(s) 310. As an illustrative example, the security control(s) 300 may provide a threat update message 320 to the threat catalog 144, where the update message 320 may include (i) a new or confirmed threat activity detected by firewall or endpoint security at the enterprise. Additionally, or in the alternative, as shown in FIG. 3B, the attack surface management system 165 may be configured to receive the top threats 290 (or top threat list 295) from the threat management system 120, which are relied upon to perform entity discovery to (i) detect additional threats and/or modifications to threats based on local enterprise analytics and (ii) provide asset inventory that may be used to modify the enterprise profile 232₁. Additionally, the attack surface management module 165 may be configured to guide vulnerability discovery of the enterprise. For vulnerability disclosure, the top threats may be used to guide in-depth investigations for vulnerabilities pertaining to these top threats, which may be used to modify or augment the threats maintained within the threat catalog 144.

Additionally, in some system configurations, the user may be adapted to access the threat catalog 144 directly as illustrated in operational flow 340. This provides the user with a holistic view of the threat landscape from which the user may determine the handling of the threats without further analytics by the threat management system 120. For a subscription-based model, this may constitute the lowest subscription tier in which threat catalog 144 is made available to the user.

Furthermore, the recommendation engine 240 is further configured to retrieve the targeted enterprise profile 232₁ associated with the enterprise, which is stored within the enterprise profile data store 230. The enterprise profile data store 230 is in communication with the user via one or more enterprise-based computing device(s) as illustrated in operational flow 345. Such communications enable the user to create the targeted enterprise profile 232₁, which includes a plurality of characteristics representative of the enterprise. The targeted enterprise profile 232₁ may be further amended based on analysis results 350 from the security analyzer devices(s) 310 and/or analysis results 355 from the security control(s) 300.

As further shown, the targeted enterprise profile 232₁ may be updated based on analytic results provided from security control(s) 300 and/or the security analyzer device(s) 310. As illustrative examples, as shown in FIG. 3C, the SOC 170 (operating as a security analyzer device 310) may be configured to receive the top threat list 295 from the threat management system 120, which are relied upon to prioritize alerts received from the security control(s) 300 and identify vulnerabilities within the enterprise associated with these alerts. The vulnerabilities can be provided to the enterprise profile 232₁ to update identified vulnerabilities maintained therein. Additionally, as shown in FIG. 3D, the security validation module 160 may be configured to return vulnerabilities discovered by selecting a test malware 360 from a test malware data store 365 based on a malware identified in the top threats 290 or related to the malware, injecting the test malware 360 into the enterprise and gathering results 370 from the security control(s) 300 to determine further enterprise vulnerabilities 375. These vulnerabilities 375 can also be provided (as part of analysis results 350) to the targeted enterprise profile 232₁ to update identified vulnerabilities maintained therein. Further information on validation and testing for enterprise vulnerabilities can be had with reference to U.S. Pat. No. 10,212,186, issued Feb. 10, 2019, entitled “Systems and methods for attack simulation on a production network,” and U.S. Pat. No. 11,349,862 issued on May 31, 2022, entitled “Systems and methods for testing known bad destinations in a production network,” the disclosures of which are incorporated herein by reference.

Referring back to FIG. 3A, based on the retrieved threat catalog 144 and the enterprise profile 232₁, the recommendation engine 240 is configured to conduct analytics to determine the relatedness between the threat attributes associated with the threats maintained by the threat catalog 144 and the enterprise characteristics from the targeted enterprise profile 232₁ pertaining to the enterprise under evaluation. Based on the relatedness, the recommendation engine 240 is able to determine the top threats 290 against the target enterprise and provide at least the top threats 290 and/or top threat list 295 to the action engine 260 and the reporting engine 270.

As further shown in FIG. 3A, the recommendation engine 240 is communicatively coupled to both the action engine 260 and the reporting engine 270. The action engine 260 may be configured to receive the top threat list 295 produced by the recommendation engine 240 and generate an action list 262 to complement each top threat within the top threat list 295. According to one embodiment of the disclosure, the action list 262 may be provided to the reporting engine 270 to be combined with the top threat list 295 and made accessible to the user. For this semi-automated data delivery, the action list 262 may include content (e.g., text, links, etc.) directed to suggested operations that require user operability before the actions are undertaken. In the alternative, the action list 262 may include commands directly sent to security analyzer device(s) 310 and/or the security control(s) 300 to control their operability in efforts to mitigate/preclude the risk of a successful cyberattack associated with the identified threat.

The reporting engine 270 is configured to generate the report 275 based at least on the top threat list 295 produced by the recommendation engine 240. The report 275 may contain a curated list of the top threats specific to the enterprise, along with other germane information provided from the recommendation engine 240 and sourced by the threat catalog 144 such as the threat's priority ranking, potential severity level (e.g., low, medium, high, or critical), or other types of information. The report 275 may further contain contents of the action list 262 as provided from the action engine 260.

### VI. Data Structures—Threat Management System

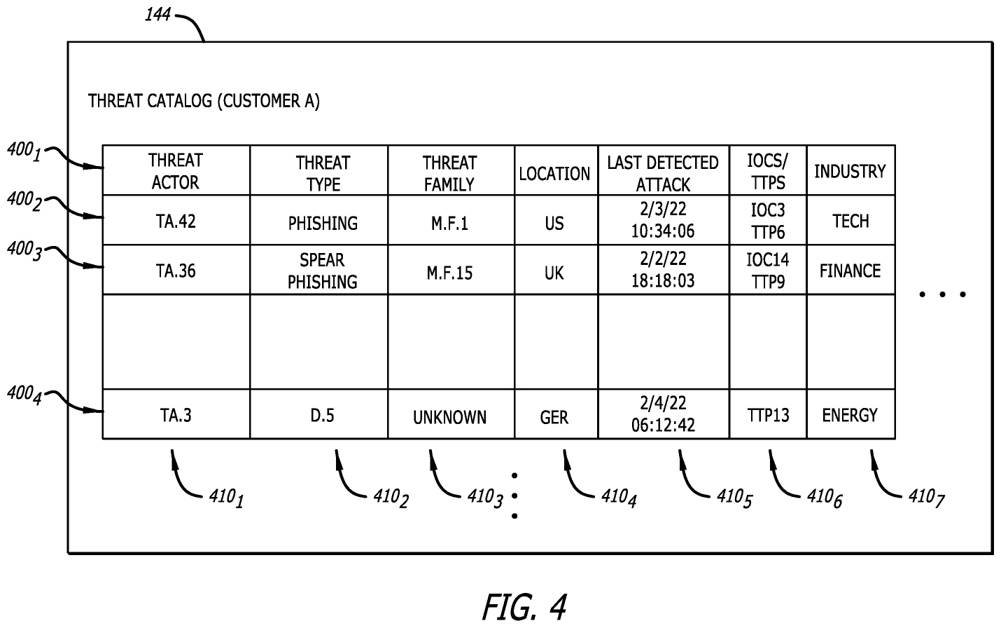

Referring now to FIG. 4, an exemplary embodiment of the threat catalog 144 deployed within the threat management system 120 of FIG. 2A is shown. Herein, the threat catalog 144 features a plurality of threats 400₁-400_{M} (M≥2), each threat includes a plurality of threat attributes 410₁-410_{P} (P≥2). As an illustrative example, the threat attributes 410₁-410_{P} associated with each of the threats 400₁-400_{M} may include, but are not limited or restricted to any or all of the following: threat actor (source of threat) 410₁, threat type 410₂, threat family 410₃, attack victim locations 410₄, last attack date 410₅, attack IoCs/TTPs 410₆, and/or attack victim industry 410₇.

Herein, the threat actor (attribute) 410₁ identifies a source of the threat. The threat actor 410₁ may operate as a filtering element, given that many threat actors or threat actor groups often tend to focus on particular industries and/or regions for example. As a result, threats associated with threat actors who concentrate cyberattacks on industries and locations different from the enterprise may realize a less threat (and result in a lesser threat ranking).

Threat type 410₂ is a threat attribute that identifies an attack vector for the threat. For enterprises concerned about certain threat types (e.g., ransomware, phishing, etc.), these threat attributes provides content to enable the recommendation engine to filter those attack vectors that do not pose a significant threat to the enterprise. For instance, the recommendation engine may filter content directed to less harmful threat types (e.g., adware) while listing threat types that are most harmful to the enterprise (e.g., ransomware, phishing, etc.).

The threat family 410₃ provides information to determine threat type when the threat is unknown, but may be associated with a particular threat family (related threats). For example, the threat family 410₃ may identify different threat families utilized by a threat actor.

The attack victim location 410₄ is a threat attribute that identifies a location or region in which similar situated threats have focused. As threat type, the location attribute provides content to enable the recommendation engine to filter threats directed to locations and regions that are not occupied by the enterprise.

The last attack date attribute 410₅ is a threat attribute that can be used to identify the “age” of the threat. This threat attribute may be useful in identifying current threats from legacy threats that may have less recent history, which may be used in assessing threat risk.

The attack IoCs/TTPs 410₆ are threat attributes that indicate suspicious activity that can be used by security analysts or administrators to determine whether an enterprise has been infiltrated by the cyberthreat. IoCs/TTPs are provided as part of a threat to provide guidance in the investigation and handling of activities to mitigate the risk associated with the threat.

The attack victim industry 410₇ is a threat attribute that identifies the industry to which the threat is directed. As threat type, the industry attribute 410₇ provides content to enable the recommendation engine to filter out threats directed to industries different than the enterprise's industry.

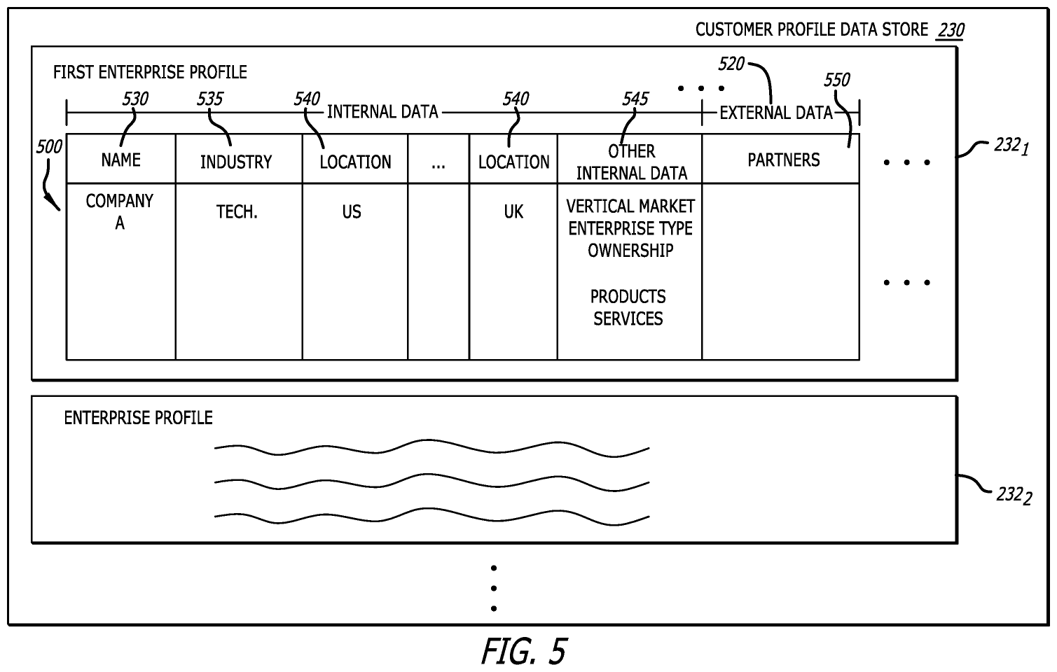

As a result, to determine the top threats, the recommendation engine 240 of FIG. 2A is configured to receive the threat catalog 144 and conduct a comparison between the threat attributes 410₁-410₇ associated with each threat 400₁-400_{M} to the characteristics set forth in the enterprise profile illustrated in FIG. 5.

Referring to FIG. 5, an exemplary embodiment of profile data store 230 deployed within the threat management system 120 of FIG. 2A is shown. Herein, the profile data store 230 includes the enterprise profiles 232₁-232_{N}, each uniquely associated with an enterprise that subscribes to service of threat ranking offered by the threat management system 120. Herein, each enterprise profile 232₁ . . . , or 232_{N} is arranged with characteristics that correspond, at least in part, to threat attributes associated with each threat maintained by the threat catalog 144 of FIG. 4.

As an illustrative example, the targeted enterprise profile 232₁ may include a plurality of characteristics 500 including, but not limited or restricted to internal data 510 and external data 520. The internal data 510 generally corresponds to information directed to the enterprise itself. Examples of internal data may include, but is not limited or restricted to its name(s) 530 (e.g., trade name(s), trademark(s) or service mark(s)), industry 535, and/or geographic location(s) 540 or regions in which the enterprise occupies. Albeit the enterprise name is a unique identifier, the industry and geographic location characteristics 535 and 540 may be used in comparison with corresponding threat attributes to identify threats that are pertinent to that enterprise. Additional internal data 545 may include vertical market, enterprise type (e.g., business, non-profit, vertical or sector, etc.), ownership (e.g., public or private), types of products and services offered by the enterprise, or the like. The other internal data may pertain to threat attributes to assist in determining threats that are applicable to the target enterprise.

In contrast, the external data 520 may include information regarding the enterprise's operating environment in relation to other entities, such as its partners 550 (as shown) as well as resellers, competitors, suppliers, and consumers. These external characteristics may be used to leverage the presence of threats against other enterprises that may be similarly situated for use in generating a robust eligible threat listing for use in ranking to provide the most applicable threats directed to the enterprise for evaluation and/or action for risk mitigation.

### VII. Engine Architectures—Threat Management System

Referring now to FIG. 6 is an exemplary embodiment of the recommendation engine 240 deployed within the threat management system 120 of FIG. 2A is shown. The recommendation engine 240 includes the correlation logic 242 and the ranking logic 244. In general, the correlation logic 242 conducts analytics on contents associated with incoming threat catalog 144 and the targeted enterprise profile 232₁ to identify threats pertaining to that enterprise (hereinafter, “eligible threats” 600). The ranking logic 244 conducts a prioritization process on the eligible threats 600 to produce the top threats 290. According to one embodiment of the disclosure, the prioritization process conducts analyses of the relatedness of threat attributes associated with the eligible threats to predetermined characteristics of the enterprise, where the results of the analyses are collected and may be adjusted to account for weighting of the results, threat severity, and confidence in the accuracy of the threat attributes for the eligible threats. As a result, the top threats concluded by the relatedness analytics may be reordered to reflect factors besides the applicability of the threat to the enterprise.

As shown in FIG. 6, the correlation logic 242 is configured to receive (i) threat attributes 610 associated with threats included in the threat profile and (ii) characteristics 615 associated with an enterprise. As an optional input, the correlation logic 242 may be configured to receive input data 620 from a customer from the enterprise. The input data may include parameters to adjust operability of components operating within the correlation logic 242 (e.g., heuristic engine(s), filter(s), etc.).

According to this embodiment of the disclosure, the correlation logic 242 includes heuristic engine(s) 630 and/or filter(s) 635. The heuristic engine(s) 630 is configured to, in response to receiving incoming content 615, to run the heuristic engine(s) 630 to determine whether the incoming content 615 (i.e. threat attributes 610 associated with threats included in the threat catalog 144) may constitute a threat against the enterprise represented by the targeted enterprise profile 232₁. Illustratively, the heuristic engine(s) 630 may conduct comparison operations between attribute-characteristic pairings for each threat (each threat attribute and its corresponding characteristic for the enterprise), where such comparisons exceed a correlation threshold. If so, the correlation logic 242 determines that the threat constitutes an eligible threat.

In contrast, in response to receiving incoming content, the filter(s) 635 are configured to run one or more filtering operations to determine whether the incoming content (i.e., known threats included in the threat catalog 144) are not applicable threats to an enterprise represented by the targeted enterprise profile 232₁. For example, the filter(s) 635 may conduct comparison operations between certain threat attributes pertaining to each threat and corresponding characteristics for the enterprise. Such comparisons exceeding a filter threshold will denote that the threat is not an eligible threat. The heuristic engine(s) 630 and the filter(s) 635 may be pre-installed within the correlation logic 242 or may be added based on customer input.

Both the heuristic engine(s) 635 and/or filter(s) 640 are configured to identify the eligible threats and, when requested by the consumer, report the eligible threats. Herein, the heuristic engine(s) 635 and/or filter(s) 640 may determine an initial degree of relevance of a threat within the threat catalog against the enterprise based on the number and/or types of threat attributes matching characteristics of the targeted enterprise profile 232₁.

Referring still to FIG. 6, the ranking logic 244 of the recommendation engine 240 is configured to receive the eligible threats 600 from the correlation logic 242 and perform a ranking (or ordering) operation on the eligible threats 600. According to one embodiment of the disclosure, the ranking operation may involve threat ordering analytics, where the ranking logic 244 conducts analytics on characteristic-attribute pairings (e.g., determine levels of correlation between characteristics of the enterprise and threat attributes associated with the eligible threats 600). These characteristic-attribute correlation levels may be determined based, at least in part, on separate rankings of different characteristic-attribute pairings that are utilized to generate rankings for the threats. Each of these characteristic-attribute pairings may include metadata (e.g., threat identifier) to associate each ranked threat attribute with its corresponding threat.

As an illustrative example, the ranking logic 244 may include a plurality of ranking logic components 650, such as a first ranking logic 652, a second ranking logic 654 and a third ranking logic 656 for example. The first ranking logic 652 is configured to generate a ranking (ordering) of threats associated with threat actors (pertaining to each of the eligible threats) who have been determined to conduct cyberattacks against industries and locations identical or related to any industry and/or locations of the enterprise. Further factors, such as time of last detected cyberattack and/or regions of the attack (e.g., local, city, state) for example, may assist in ranking of threat actors based on their concentration on enterprises within a certain location

The ranking logic 244 further includes the second ranking logic 654 configured to generate a ranking of threats based on the type of malware associated with that threat. Herein, the second ranking logic 654 may evaluate the malware based on its specificity and/or malicious activity. For example, the second ranking logic 654 may be configured to determine whether the malware is targeting a specific industry or a particular enterprise that is related to the enterprise under evaluation or malware that disrupts network communications. If so, the second ranking logic 654 may accord a higher ranking to the malware than malware directed to adware and applicable to all industries.

The ranking logic 244 further includes a third ranking logic 656 configured to generate a ranking the threats based on the IoCs and/or TTPs pertaining to the malware. This ranking is performed to take into account attack vectors and/or vulnerabilities that may constitute aspects of higher concern to the enterprise.

From the characteristic-attribute rankings produced by the ranking logic 650 and corresponding metadata, an initial top threat list (corresponding to a prescribed number of cataloged threats having the highest overall ranking after aggregation of the characteristic-attribute rankings 653/655/657 produced from ranking logic 626/654/656) is determined,

After generation of an initial top threat list, the ranking logic 244 may be configured to apply ranking adjustments to generate the top threat list 295 that may be distributed to other components within the threat management system 120, the consumer associated with the enterprise and/or security analyzer device(s) associated with the threat management system to provide holistic management and protection of customers' enterprises, and security control(s) within the enterprise itself. The adjustments may be performed by adjustment logic 660.

According to one embodiment of the disclosure, the adjustment logic 660 is configured to adjust the initial top threat list 251 based on one or more factors, such as the weighting associated with the analytic results produced by the ranking logic 630/640/650, threat severity, and/or confidence in the threat attributes as briefly described in FIG. 2B.

As shown in FIG. 6, the weighting adjustment logic 670 may be configured to apply a weighting of different aggregated characteristic-attribute rankings to place more importance on some rankings and less importance on others. For example, the threat actor ranking 653 and the malware ranking 655 may be assigned a greater weighting than the IoCs/TTPs ranking 657, where the weighting may be conducted to take into account the current threat landscape or customer preferences. However, according to another embodiment of the disclosure, the weighting adjustment logic 670 may be disabled (or set to a non-weighting distribution) when no weighting is to be applied.

Severity adjustment logic 672 may be directed to the severity levels assigned to the threats. According to one embodiment of the disclosure, the threat severity level may be used to exclude threats from the top threat list with severity levels that are less than a first prescribed risk threshold. As a result, where one of the eligible threats that is highly applicable to the enterprise but the severity of the threat is low, the ranking of the threat may be adjusted downward (or fall off) of the top threat list. Additionally, or in the alternative, the severity adjustment logic 672 may be used to adjust the overall rankings in which threats with higher severity levels may be elevated on the top threat list.

Herein, a severity level may be represented by a threat score depends on a number of risk factors such as determined levels of maliciousness and/or scope, extent of potential damage/distribution to the enterprise based on heuristics of similarly situated enterprises subject to a cyberattack, the urgency of remediation, or other risk factors inclusive of the active threat actors and/or malware pertaining to the on heuristics associated with the damage caused by such cyberattacks.

Additionally, the adjustment logic 660 further includes confidence adjustment logic 674, which is configured to conduct a ranking adjustment based on a level of confidence in the accuracy of the threat attributes. This level of confidence may be represented by a quality value associated with the threat (e.g., its attributes used in the correlation) or associated with a source in reporting of the corresponding threats. Therefore, where the confidence adjust logic 674 determines whether an eligible threat features a quality value that is equal to or exceed a first prescribed threshold, and if so, the confidence adjustment logic 674 may retain the ordering of the initial top threat list or adjust accordingly depending on the confidence levels for the other threats. However, if the quality value falls below a second prescribed threshold, which may be the same or lower than the first prescribed threshold, the threat ranking of the threat may be reduced.

Alternatively, in lieu of the top threat list 295 formulated on a threat-by-threat ordering, the ranking logic 244 may be configured to generate a tier segmentation of the threats, where threats with certain threat scores are gathered together. Hence, the top threat list 295 may be provided as a listing of threats within each threat tier group that may be segmented by threat score associated with the threats.

The operability of the correlation logic 242 and the ranking logic 244 may be automated to allow the top threat list to be updated to the most current information in response to changes in the threat catalog 144 or the enterprise profile 232₁. This automated update may be conducted from time to time (e.g., periodicity) to ensure that resources allocated in protecting the enterprise from cyberattacks are utilized efficiently, and reports of those top threats may be enriched with additional details useful to defend against those threats.

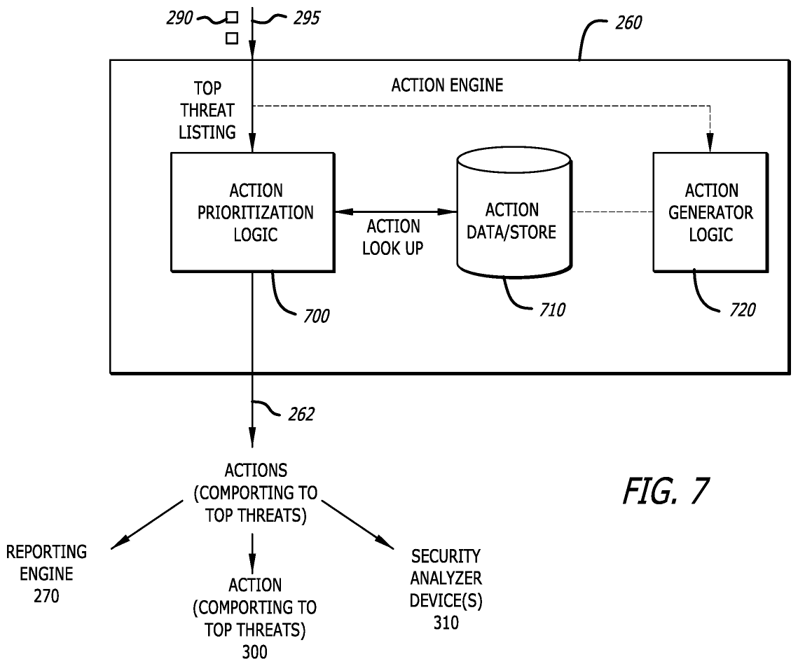

Referring to FIG. 7 is an exemplary embodiment of the action engine 260 deployed within the threat management system 120 of FIG. 2A is shown. Communicatively coupled to the recommendation engine 240, the action engine 260 is configured to receive the top threat list 295 and generate the action list 262 to complement some or all of the threats set forth in the top threat list. According to one embodiment of the disclosure, the action list 262 may include information (e.g., text, links, etc.) directed to suggested operations to be conducted by a customer on or by the security analyzer devices and/or the security controls to mitigate/neutralize the risk of a successful cyberattack associated with the identified threat. According to another embodiment of the disclosure, the action list 262 may include commands directly sent to security analyzer device(s) and/or the security control(s) to control their operability in efforts to mitigate/preclude the risk of a successful cyberattack associated with the identified threat. The commands may be sent automatically (automated) or in response to active selection of the action by the security administrator (semi-automated).

Herein, the action engine 270 features action prioritization logic 700, an action data store 710 and action generator logic 720. As shown, upon receipt, the top threats 290 and/or the top threat list 295 is provided to both the action prioritization logic 700 and the action generator logic 720. The action prioritization logic 700 is configured to establish a priority (order) of actions to be suggested or undertaken in accordance with an ordering of threats included in the top threat list 295. The action generator logic 720 is responsible for generating, as needed, a series of actions to mitigate or neutralize one or more threats set forth in the top threat list 295. In particular, the action generator 720 may be configured to access the action data store 710 to determine whether an action list is stored for addressing each top threat included in the top threat list 295. This may be accomplished by conducting a look-up of the action lists within the action data store 710 to determine whether any action lists pertain to a threat represented by a threat identifier, included as metadata with the top threat list 295.

If the action list is already stored within the action data store 710, the action generator logic 720 halts further operations to generate the action list. However, if the action list is not stored within the action data store 710, the action generator logic 720 conducts analytics on the threat attributes of a threat without a corresponding action list, including correlation of these threat attributes with attributes of other threats to determine which threats are related to a threat without an action list and to use action list(s) associated with the related threat(s) as a template in the creation of the action list. The analytics are directed to reduce adverse effects caused by the threat if an attack is initiated.

Besides providing the action list 262 to the reporting engine 270, with the top threat list or with information that allows a targeted destination access to the action list, the action list 262 may be provided as part of a message to the security control(s) of the enterprise in order to adjust operability of the security control(s) 300. Additionally, the action list 262 may be provided (as part of a message) to security analyzer device(s) 310 to guide operability of these devices in conducting further analyses of the enterprise to assist in hardening the security control(s) 300 associated with the enterprise.

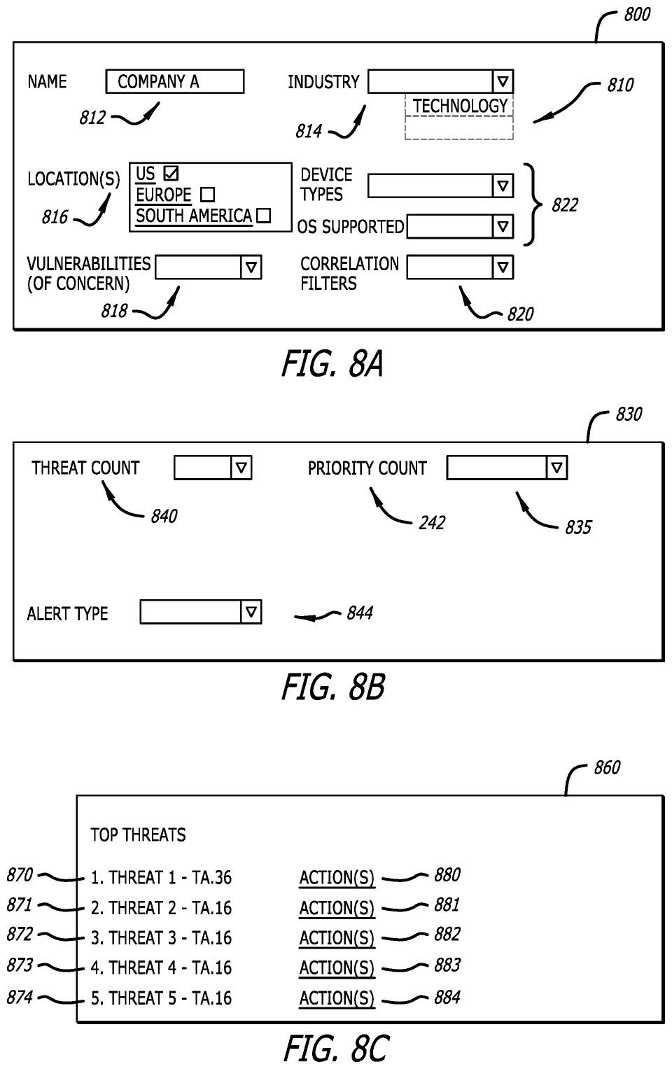

Referring now to FIG. 8A, an exemplary embodiment of an illustrative enterprise profile display interface 800, generated by the threat management system 120 of FIG. 2A and accessible by an enterprise via the portal 132 or API 134, is shown. Herein the profile display interface 800 includes display elements 810 to allow the customer to create and update its enterprise profile. As shown, the display elements 810 may be modified manually by the customer or automatically based on received analytic results from the security analyzer devices as illustrated in FIGS. 3B-3D. Herein, as an illustrative example, the display elements 810 may include, but are not limited or restricted to (i) a “name” display element 812, (ii) an “industry” display element 814, (iii) a “location” display element 816, (iv) a “vulnerabilities” display element 818, (v) “correlation filter” display element 820,/or (vi) enterprise environment display element(s) 822.

According to this embodiment of the disclosure, the “name” display element 812 provides an input field for assigning a unique identifier for the enterprise profile. Also, the characteristic may be used in identifying threats targeted to a specific enterprise or group of enterprises to which the enterprise belong. The “industry” display element 814 provides a field for selection of the industry or industries associated with the enterprise, which can be updated as the enterprise grows or contracts. The “location” display element 816 provides an entry field for the locations of the enterprise. As shown, the locations may be based on continent or country, and upon selection of the continent/country link, additional regions applicable to the continent/country may be provided. This allows for more precise regions of the enterprise to be identified, which may assist in the threat ranking process performed by the ranking logic 244 of FIG. 6.

The “vulnerabilities” display element 818 provides a field for selection of vulnerabilities currently present within the enterprise. These vulnerabilities may be entered by the consumer based on internal review of the enterprise architecture or may be automatically populated based on findings by the security analyzer device(s). Similarly, the enterprise environment display element(s) 822 provides a field for entry for selection of computing device types operating within the enterprise as well as core software components relied upon by the computing devices. This information improves the accuracy of the threat ranking by focusing on threats directed to particular software components and discount threats directed to software components that are not used in the enterprise.

Lastly, the “correlation filter” display element 820 provides a field for selection of correlation filters directed to threats that, according to the customer, are more important to its viability than other threats. This allows the customer to have an ability to customize determination of eligible threats based on the enterprise's concerns.

Referring now to FIG. 8B, an exemplary embodiment of a display interface 830 generated by the reporting engine 370 of the threat management system 120 of FIG. 2A is shown. The display interface 830 provides the customer with an ability to tailor the display and handling of the top threat list. Herein, the display elements 835 associated with the display interface 830 include, but are not limited or restricted to (i) a “threat count” display element 840, (ii) a “priority count” display element 842, and/or (iii) an “alert type” display element 844.

Herein, the threat count display element 840 provides a field for selection of the number of threats to be included as part of the top threat list. For example, the number may range from five (5) threat to ten (10) threat, twenty (20) threats, fifty (50) threats or all threats.

Additionally, the top threats identified in the top threat list may be segmented into two or more tiers, where each of the tiers are associated with a subset of the ranked eligible threats. The tiers may represent different priority levels for investigation of the threats (and the security control(s) installed to combat these threats). This may be accomplished by the priority count display element 842, which provides a field for selection of the number of threats to be assigned to each tier as part of the top threat list. For example, the number may range from five (5) threat, ten (10) threat, twenty (20) threats, or the like.

Lastly, the “alert type” display element 844 is configured to select one or more delivery mechanisms for a report. Examples of these delivery mechanisms may include electronic mail message, text message with link to the report, automated audio recording of the report particulars, etc.

Referring now to FIG. 8C, an exemplary embodiment of a display 860 generated by the recommendation engine 240 and the action engine 260 of the threat management system 120 of FIG. 2A is shown. The display 860 is a representation of the top threat list 295, which features a prescribed number of top threats 870-874 along with complementary links 880-884 to action lists. According to one embodiment of the disclosure, each action list may include links to initiate the transmission of commands to identified security control(s) and/or the transmission of textual data suggesting operations (and order of operations) to be conducted by the customer to mitigate/preclude the risk of a successful cyberattack associated with the identified threat. According to this embodiment of the disclosure, the display 860 provides for semi-automated actions to be conducted for each of the top threats.

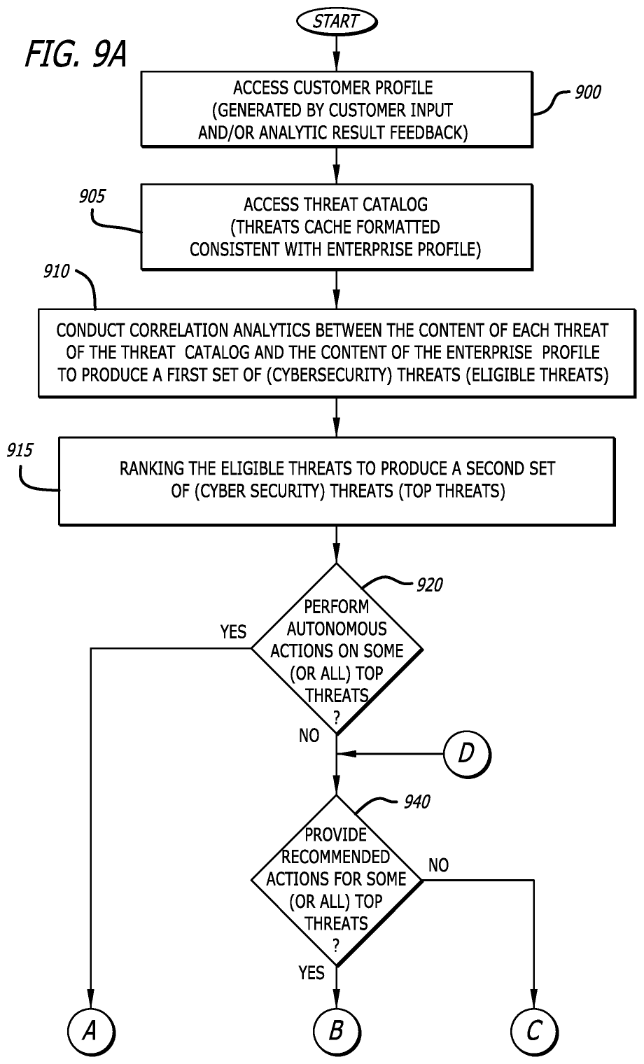

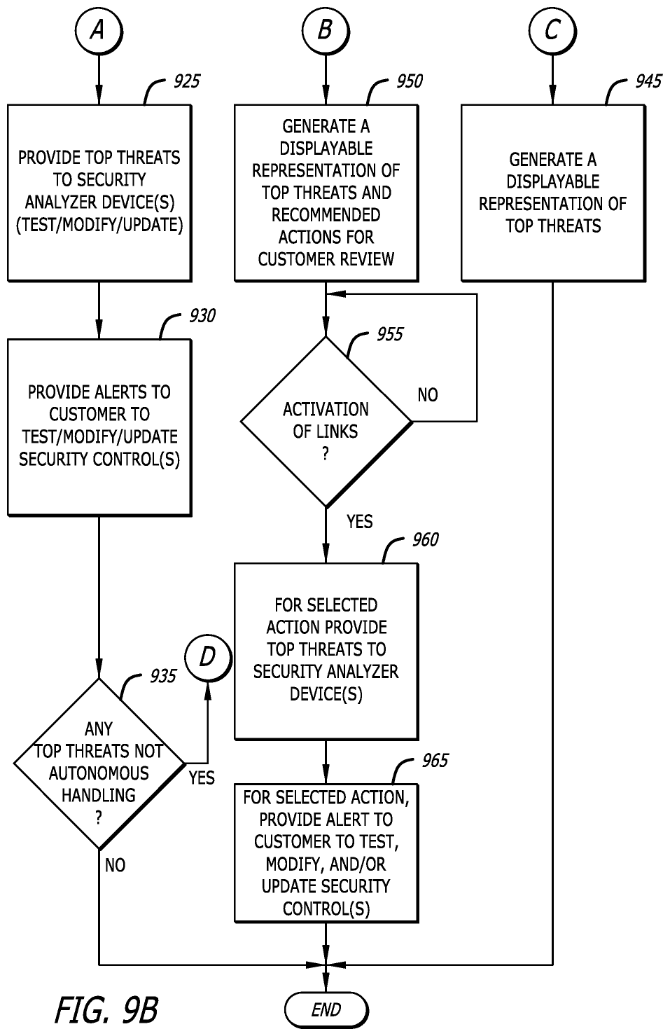

Referring now to FIGS. 9A-9B, an exemplary embodiment of the operational flow of the threat management system 120 to determine threats directed to an enterprise, rank the determined threats, and generate recommended actions associated with at least a prescribed number of the top-ranked threats is shown. Herein, after gaining access to the enterprise profile and the threat catalog, the threat management system conducts correlation analytics between the contents (threat attributes) of each threat and characteristics associated with the enterprise profile to produce a first set of cybersecurity threats, referred to as “eligible threats” (blocks 900, 905 and 910). Thereafter, the eligible threats are ranked to produce a second set of cybersecurity threats, referred to herein as the “top threats” (block 915).

After generation of the top threats, a determination is made as to whether autonomous actions are to be taken on some (or all) of the top threats (block 920). If so, the top threat may be provided to security analyzer device(s) to conduct testing, and based on the results, adding, modifying or updating security control(s) deployed within the enterprise and/or commands associated with determined actions to mitigate and/or eliminate the threats are provided to the security control(s) associated with the customer (blocks 925-930).

If any or all of the top threats are not to be handled autonomously, a determination is made whether the suggestions associated with recommended actions to mitigate and/or neutralize the threats may be provided to the customer (blocks 935-940). If not, a displayable representation of the top threats may be provided to the customer to evaluate the handling of the threats independently (block 945). However, if a semi-autonomous handling of the top threats is desired, a displayable representation of the top threats and recommended actions (as textual information, links, etc.) is provided to the customer (block 950). In response to activation of links associated with the recommended action, the top threats may be provided to security analyzer device(s) and/or security control(s), depending on the type of action to be conducted such as testing, modifying settings, updating software, or the like (blocks 955, 960 and 965).

In the foregoing description, the invention is described with reference to specific exemplary embodiments thereof. However, it will be evident that various modifications and changes may be made thereto without departing from the broader spirit and scope of the invention as set forth in the appended claims.

What is claimed is:

1. A cloud-based security system, comprising:
a threat management system to generate a top threat list based on a correspondence between (i) content of an enterprise profile associated with an enterprise to which threats associated with the top threat list are directed and (ii) content of a threat catalog included in the threat management system;
an interactive portal to receive information over a network regarding the enterprise, the enterprise profile including a plurality of characteristics of the enterprise included in the received information; and
one or more security analyzer devices coupled to the threat management system,
wherein the top threat list corresponds to an arrangement of a subset of threats prioritized, based on characteristics of the enterprise included in the enterprise profile and attributes associated with the threats, for assisting the enterprise in taking preventive or remedial actions in addressing the top threats.

2. The cloud-based security system of claim 1, wherein the top threat list identifies detected threats associated with a cybersecurity posture of the enterprise.

3. The cloud-based security system of claim 1, wherein the subset of threats is provided to a security analyzer device of the one or more security analyzer devices.

4. The cloud-based security system of claim 3, wherein the security analyzer device is configured to update the enterprise profile based on results of analytics performed by the security analyzer device.

5. The cloud-based security system of claim 3, wherein the security analyzer device includes a security validation module configured to select a test malware based on one or more threats identified in the top threat list to be injected into a network of the enterprise where operability of security controls within the network of the enterprise are monitored.

6. The cloud-based security system of claim 3, wherein the security analyzer device includes an active surface management module that controls areas of investigation for vulnerabilities of the enterprise based on threats included in the top threat list.

7. The cloud-based security system of claim 3, further including a security operations center (SOC) comprising the security analyzer device used to prioritize alerts based on threats identified in the top threat list and prioritize actions to mitigate risks associated with the threats pertaining to the alerts.

8. The cloud-based security system of claim 1, wherein the enterprise profile includes the characteristics associated with the enterprise and the threat catalog includes a plurality of threat attributes each associated with a threat extracted from a compilation of known threats collected by one or more threat intelligence sources remotely located from the threat management system.

9. The cloud-based security system of claim 8, wherein the threat management system comprises a recommendation engine configured to determine eligible threats associated with one or more threat attributes pertaining to different threats maintained by the threat catalog, having a prescribed level of correlation with one or more characteristics of the plurality of characteristics included in the enterprise profile.

10. The cloud-based security system of claim 8, wherein the recommendation engine is further configured to receive the eligible threats and perform a ranking on the eligible threats.

11. The cloud-based security system of claim 1, wherein the interactive portal comprises an application programming interface (API) to support communications with a computing device of the enterprise to enable a customer associated with the enterprise to receive a report including the top threat list including characteristics of the enterprise to provide context as to one or more threats included in the top threat list.

12. The cloud-based security system of claim 11, wherein the characteristics of the enterprise include internal data corresponding to information directed to the enterprise including a name of the enterprise, an industry of the enterprise industry, and geographic location or regions occupied by the enterprise.

13. A computerized method comprising:
receiving, by a security analyzer device, a top threat list including a plurality of cybersecurity threats prioritized for an enterprise subscribing to a threat management system;
conducting analytics of incoming information to determine a level of correlation between at least a portion of the incoming information and any of the plurality of cybersecurity threats within the top threat lists content; and
upon determining the level of correlation between the portion of the incoming information and a cybersecurity threat of the plurality of cybersecurity threats exceeding a first threshold, conducting operations to perform preventive or remedial action in addressing the cybersecurity threat.

14. The computerized method of claim 13, wherein the top threat list is based on a correspondence between (i) content of an enterprise profile associated with the enterprise to which threats associated with the top threat list are directed and (ii) content of a threat catalog included in the threat management system.

15. The computerized method of claim 13, wherein the security analyzer device includes a security validation module configured to select a test malware based on one or more cybersecurity threats identified in the top threat list to be injected into a network of the enterprise and monitor operability of security controls within the network of the enterprise.

16. The computerized method of claim 13, wherein the security analyzer device includes an active surface management module that controls areas of investigation for vulnerabilities of the enterprise based on one or more cybersecurity threats included in the top threat list.

17. The computerized method of claim 13, further including a security operations center (SOC) that includes the security analyzer device used to prioritize alerts based on one or more cybersecurity threats identified in the top threat list and prioritize actions to mitigate risks associated with the one or more cybersecurity threats pertaining to the alerts.

18. A non-transitory storage medium including software that, upon execution, detects cybersecurity threats identified by a top threat list faced by an enterprise, the non-transitory storage medium comprising:
logic to receive the top threat list including a plurality of cybersecurity threats prioritized for the enterprise subscribing to a threat management system; and
logic to conduct analytics of incoming information to determine a level of correlation between at least a portion of the incoming information and any of the plurality of cybersecurity threats within the top threat lists content;
logic configured to, when the level of correlation between the portion of the incoming information and a cybersecurity threat of the plurality of cybersecurity threats exceeding a first threshold, conduct preventive or remedial actions in addressing the cybersecurity threat.

19. The non-transitory storage medium of claim 18, further including logic to generate an enterprise profile based on information related to the enterprise.

20. The non-transitory storage medium of claim 19, wherein the enterprise profile logic generates a plurality of enterprise profiles, each based on information related to a different enterprise of a plurality of enterprises including the enterprise, and causes the plurality of enterprise profiles to be stored in an enterprise profile store.
